(19) United States
(12) Patent Application Publication
(10) Pub. No.: US 2022/0207304 A1
(43) Pub. Date: Jun. 30, 2022

(54) ROBUSTNESS SETTING DEVICE, ROBUSTNESS SETTING METHOD, STORAGE MEDIUM STORING ROBUSTNESS SETTING PROGRAM, ROBUSTNESS EVALUATION DEVICE, ROBUSTNESS EVALUATION METHOD, STORAGE MEDIUM STORING ROBUSTNESS EVALUATION PROGRAM, COMPUTATION DEVICE, AND STORAGE MEDIUM STORING PROGRAM

(71) Applicant: NEC Corporation, Minato-ku, Tokyo (JP)

(72) Inventor: Hiroshi HASHIMOTO, Tokyo (JP)

(73) Assignee: NEC Corporation, Minato-ku, Tokyo (JP)

(21) Appl. No.: 17/606,808

(22) PCT Filed: May 7, 2020
(86) PCT No.: PCT/JP2020/018554

§ 371 Date: Oct. 27, 2021

(30) Foreign Application Priority Data
May 10, 2019 (JP) 2019-090066

(51) Int. Cl. G06K 9/62; G06F 11/14; G06F 21/55

(52) U.S. Cl. CPC G06K 9/6262; G06F 21/55; G06F 11/1476

(57) ABSTRACT

A robustness setting device provided with robustness specifying means for specifying a robustness level required in a computation device using a trained model against an adversarial sample that is an input signal to which a perturbation has been added in order to induce an erroneous determination by the trained model; and level determination means for determining a noise removal level for the input signal based on the robustness level.

### TECHNICAL FIELD

The present invention pertains to a robustness setting device, a robustness setting method, a storage medium storing a robustness setting program, a robustness evaluation device, a robustness evaluation method, a storage medium storing a robustness evaluation program, a computation device, and a storage medium storing a program, regarding robustness against adversarial samples (adversarial examples), which are input signals to which perturbations have been added in order to induce erroneous determinations in a trained model.

### BACKGROUND ART

Machine learning using neural networks, such as deep learning, is utilized in various information processing fields. However, machine learning models such as neural networks are known to be vulnerable against adversarial samples, which are also known as adversarial examples.

Patent Document 1 discloses technology for retraining a neural network by using adversarial examples in order to provide the neural network with robustness to adversarial examples.

### CITATION LIST

### Patent Literature

[Patent Document 1]
U.S. patent Ser. No. 10/007,866

### SUMMARY OF THE INVENTION

### Problems to be Solved by the Invention

In order to retrain a trained model as in the technology described in Patent Document 1, a sufficient number of adversarial samples for training must be prepared. For this reason, a technology for more simply providing robustness against adversarial samples is required.

The example of purpose of the present invention is to provide a robustness setting device, a robustness setting method, a storage medium storing a robustness setting program, a robustness evaluation device, a robustness evaluation method, a storage medium storing a robustness evaluation program, a computation device, and a storage medium storing a program that can simply provide a computation device that uses a trained model with robustness against adversarial samples.

### Means for Solving the Problems

According to a first aspect of the present invention, a robustness setting device includes robustness specifying means for specifying a robustness level required in a computation device using a trained model against an adversarial sample that is an input signal to which a perturbation has been added in order to induce an erroneous determination by the trained model; and level determination means for determining a noise removal level for the input signal based on the robustness level.

According to a second aspect of the present invention, a robustness setting method involves specifying a robustness level required in a computation device using a trained model against an adversarial sample that is an input signal to which a perturbation has been added in order to induce an erroneous determination by the trained model; and determining a noise removal level for the input signal based on the robustness level.

According to a third aspect of the present invention, a robustness setting program stored on a storage medium makes a computer execute processes for specifying a robustness level required in a computation device using a trained model against an adversarial sample that is an input signal to which a perturbation has been added in order to induce an erroneous determination by the trained model; and determining a noise removal level for the input signal based on the robustness level.

According to a fourth aspect of the present invention, a robustness evaluation device includes sample generation means for generating multiple adversarial samples for each of multiple perturbation levels for inducing an erroneous determination by a trained model; accuracy specifying means for specifying an output accuracy of a computation device using the trained model with respect to the adversarial samples for each of the multiple perturbation levels; and presentation means for presenting information indicating a robustness level of the computation device against the adversarial samples based on the output accuracy for each of the multiple perturbation levels.

According to a fifth aspect of the present invention, a robustness evaluation method involves generating multiple adversarial samples for each of multiple perturbation levels for inducing an erroneous determination by a trained model; specifying an output accuracy of a computation device using the trained model with respect to the adversarial samples for each of the multiple perturbation levels; and presenting information indicating a robustness level of the computation device against the adversarial samples based on the output accuracy for each of the multiple perturbation levels.

According to a sixth aspect of the present invention, a robustness evaluation program stored on a storage medium makes a computer execute processes for generating multiple adversarial samples for each of multiple perturbation levels for inducing an erroneous determination by a trained model; specifying an output accuracy of a computation device using the trained model with respect to the adversarial samples for each of the multiple perturbation levels; and presenting information indicating a robustness level of the computation device against the adversarial samples based on the output accuracy for each of the multiple perturbation levels.

According to a seventh aspect of the present invention, a computation device includes noise removal means for performing a noise removal process on an input signal based on a noise removal level determined by the robustness setting method according to an embodiment described above; and computation means for obtaining an output signal by inputting, to a trained model, the input signal that has been quantized.

According to an eighth aspect of the present invention, a computation method involves performing a noise removal process on an input signal based on a noise removal level determined by the robustness setting method according to an embodiment described above; and obtaining an output signal by inputting, to a trained model, the input signal that has been quantized.

According to a ninth aspect of the present invention, a program stored on a storage medium makes a computer execute processes for performing a noise removal process on an input signal based on a noise removal level determined by the robustness setting method according to an embodiment described above; and obtaining an output signal by inputting, to a trained model, the input signal that has been quantized.

### Advantageous Effects of Invention

According to at least one of the above-described embodiments, a computation device using a trained model can be simply provided with robustness against adversarial samples.

### BRIEF DESCRIPTION OF THE DRAWINGS

FIG. 1 is a schematic block diagram illustrating a structure of a robustness setting system according to a first embodiment.

FIG. 2 is a flow chart indicating a robustness setting method in the robustness setting system according to the first embodiment.

FIG. 3 is a flow chart indicating operations of a computation device after acquiring robustness according to the first embodiment.

FIG. 4 is a schematic block diagram illustrating a structure of a robustness setting system according to a second embodiment.

FIG. 5 is a flow chart indicating a robustness setting method in the robustness setting system according to the second embodiment.

FIG. 6 is a schematic block diagram illustrating a structure of a robustness setting system according to a third embodiment.

FIG. 7 is a flow chart indicating a robustness setting method in the robustness setting system according to the third embodiment.

FIG. 8 is a schematic block diagram illustrating a structure of a robustness setting system according to a fourth embodiment.

FIG. 9 is a schematic block diagram illustrating a structure of a robustness evaluation system according to a fifth embodiment.

FIG. 10 is a flow chart indicating a robustness evaluation method in the robustness evaluation system according to the fifth embodiment.

FIG. 11 is a schematic block diagram illustrating a basic structure of a robustness setting device.

FIG. 12 is a schematic block diagram illustrating a basic structure of a computation device.

FIG. 13 is a schematic block diagram illustrating a basic structure of a robustness setting device.

FIG. 14 is a schematic block diagram illustrating a structure of a computer according to at least one embodiment.

### EXAMPLE EMBODIMENT

### First Embodiment

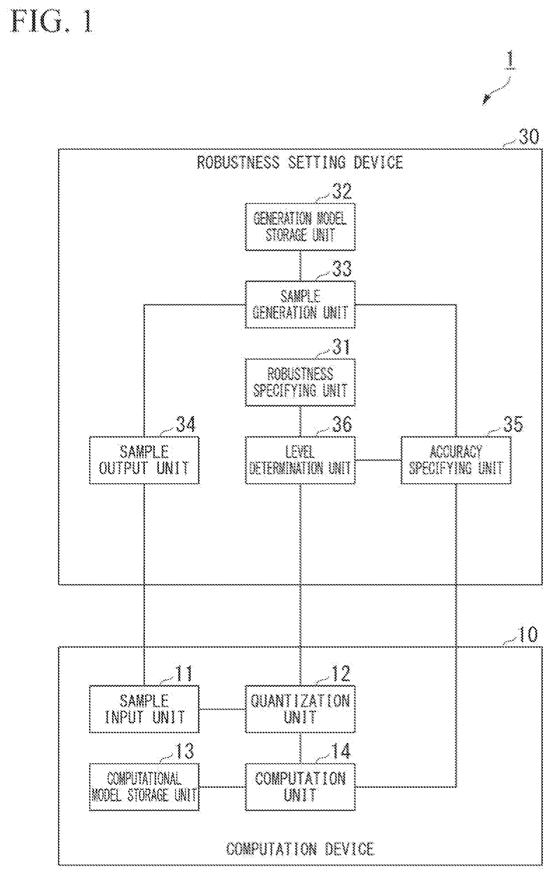

FIG. 1 is a schematic block diagram illustrating a structure of a robustness setting system according to a first embodiment.

The robustness setting system 1 is provided with a computation device 10 and a robustness setting device 30.

### <<Structure of Computation Device>>

The computation device 10 performs computations using a trained model. A trained model refers to a combination of a machine learning model and learned parameters obtained by training. An example of a machine learning model is a neural network model or the like. Examples of the computation device 10 include identification devices that perform identification processes based on input signals such as images, and control devices that generate machine control signals based on input signals from sensors or the like.

The computation device 10 is provided with a sample input unit 11, a quantization unit 12, a computational model storage unit 13, and a computation unit 14.

The sample input unit 11 receives, as an input, an input signal that is a computation target of the computation device 10.

The quantization unit 12 quantizes the input signal input to the sample input unit 11 to a prescribed quantization width. The quantization width of the quantization unit 12 is set by the robustness setting device 30. The quantization width before being set by the robustness setting device 30 is set to zero as an initial value. The quantization width being zero is equivalent to the quantization unit 12 outputting the input signal to the computation unit without performing a quantization process. In the quantization process, the quantization unit 12 performs value round-up and round-down processes based on the quantization width, without changing the number of quantization bits in the input signal. The quantization process is an example of a noise removal process. That is, the quantization unit 12 is an example of a noise removal unit.

The computational model storage unit 13 stores a computational model, which is a trained model.

The computation unit 14 obtains an output signal by inputting the input signal quantized by the quantization unit 12 to the computational model stored in the computational model storage unit 13.

### <<Structure of Robustness Setting Device>>

The robustness setting device 30 sets the robustness of the computation device 10 to adversarial samples. Adversarial samples refer to input signals to the computation device 10 wherein perturbations have been added to the input signals in order to induce erroneous determinations in a trained model. The robustness setting device 30 generates adversarial samples that induce amounts of change in computational accuracy corresponding to the robustness (robustness level). As examples of adversarial samples, there are adversarial examples.

The robustness setting device 30 is provided with a robustness specifying unit 31, a generation model storage unit 32, a sample generation unit 33, a sample output unit 34, an accuracy specifying unit 35, and a level determination unit 36.

The robustness specifying unit 31 receives, as an input from a user, an amount of change in the computational accuracy of the computation device 10 due to adversarial samples as a robustness level against the adversarial samples. In other words, the robustness setting device 30 provides the computation device 10 with robustness against the adversarial samples such as to result in a decrease in the computational accuracy in accordance with the change amount that has been input. Examples of the computational accuracy change amount include computational accuracy reduction rates and the like. The computational accuracy is, for example, a correct response rate, an error rate, a standard deviation of error or the like of output signals. The computational accuracy change amount indicates a prescribed correct response rate, error rate, standard deviation of error or the like, or a degree of reduction in these values.

The generation model storage unit 32 stores a generation model, which is a model for generating adversarial samples on the basis of input signals. A generation model is, for example, represented by the function indicated by Expression (1) below. That is, an adversarial sample xₐ is generated by adding a perturbation to an input signal x. The perturbation is obtained by multiplying a perturbation level ε to the sign of the slope ΔₓJ of the computational model for input signals x. The slope ΔₓJ can be calculated by backpropagating correct response signals to input signals x in the computational model. The “sign” function in Expression (1) represents a step function for quantizing the sign to a binary ±value. Expression (1) is one example of a generation model, and the generation model may be represented by another function.

xₐ=x+ε·sign(ΔₓJ) . . . (1)

The sample generation unit 33 generates an adversarial sample by inputting a test dataset input signal, which is a combination of an input signal and a correct response signal, into a generation model stored by the generation model storage unit 32. The sample generation unit 33 generates an adversarial sample in accordance with the perturbation level ε by changing the perturbation level ε in the computational model. The sample generation unit 33 specifies a correct response signal (output signal) associated with the input signal as a correct response signal for the generated adversarial sample. If the perturbation level ε is low, then the adversarial sample input signal will be a signal similar to the test dataset input signal. However, if the perturbation level ε is high, then the adversarial sample input signal will be a signal for which the probability of misidentification by the computation device 10 is high. As described above, for example, the input signal represents an image, and the output signal represents an identification result. In another example, the input signal represents a measurement value by a sensor or the like, and the output signal represents a control signal.

The sample output unit 34 outputs adversarial samples generated by the sample generation unit 33 to the computation device 10. In other words, the sample output unit 34 makes the computation device 10 perform calculations having the adversarial samples as inputs.

The accuracy specifying unit 35 compares the output signals generated by the computation device 10 on the basis of the adversarial samples with correct response signals specified by the sample generation unit 33, and specifies the accuracy of the computation device 10 for each perturbation level.

The level determination unit 36 determines the quantization width of the quantization process performed by the quantization unit 12 in the computation device 10 on the basis of the robustness level specified by the robustness specifying unit 31 and the accuracy of the computation device 10 specified by the accuracy specifying unit 35. The quantization width is an example of a quantization parameter, and is an example of a noise removal level. Specifically, the level determination unit 36 determines the quantization width as a value that is twice the perturbation level ε when the computational accuracy changed by an amount corresponding to the change amount that was provided as the robustness level. This will be explained in more detail below. The level determination unit 36 sets the determined quantization width in the computation device 10.

### <<Operations of Robustness Setting System>>

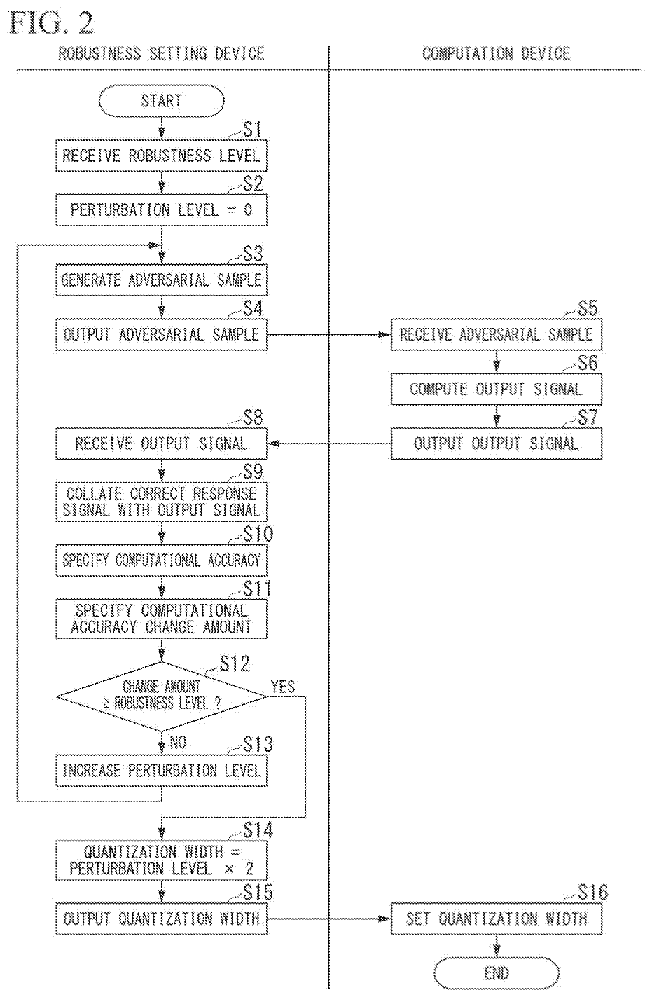

FIG. 2 is a flow chart indicating a robustness setting method in the robustness setting system according to the first embodiment.

First, a user inputs, to the robustness setting device 30, a computational accuracy change amount as a robustness level required in the computation device 10. The user inputs, as the desired robustness level, the degree to which the computational accuracy of the computation device 10 is to be reduced. The robustness specifying unit 31 in the robustness setting device 30 receives the computational accuracy change amount that has been input (step S1).

The sample generation unit 33 sets the initial value of the perturbation level to be zero (step S2). The sample generation unit 33 generates multiple adversarial samples based on input signals associated with known test datasets, the set perturbation level, and the generation model stored by the generation model storage unit 32 (step S3). Thus, the sample generation unit 33 generates multiple input signals to which perturbations at the perturbation level have been added. The generation of adversarial samples has been explained above. The sample output unit 34 outputs the multiple adversarial samples that have been generated to the computation device 10 (step S4).

The sample input unit 11 in the computation device 10 receives the multiple adversarial samples as inputs from the robustness setting device 30 (step S5). The computation unit 14 inputs each of the multiple adversarial samples that have been received to the computational model stored in the computational model storage unit 13, and computes multiple output signals (step S6). At this time, the quantization width is not set, and the quantization width is the initial value of zero. That is, the quantization unit 12 does not perform a quantization process. The computation unit 14 outputs the multiple output signals that have been computed to the robustness setting device 30 (step S7).

The accuracy specifying unit 35 in the robustness setting device 30 receives the multiple output signals as inputs from the computation device 10 (step S8). The accuracy specifying unit 35 collates correct response signals corresponding to the input signals used to generate the adversarial samples in step S3 with the output signals that have been received (step S9). The accuracy specifying unit 35 pre-stores the correct output signals (correct response signals) corresponding to the input signals. The accuracy specifying unit 35 specifies the computational accuracy of the computation device 10 based on the collation results (step S10). As described above, examples of computational accuracy include a correct response rate, an error rate, a standard deviation of error, and the like.

The accuracy specifying unit 35 specifies the computational accuracy change amount on the basis of the computational accuracy specified in step S10 and the computational accuracy associated with an adversarial sample when the perturbation level is zero (i.e., a normal input signal) (step S11). The computational accuracy associated with an adversarial sample when the perturbation level is zero is the computational accuracy computed by the robustness setting device 30 in the first step S10 in the robustness setting process.

The level determination unit 36 determines whether or not the computational accuracy change amount specified in step S11 is equal to or greater than the change amount associated with the robustness level received in step S1 (step S12).

If the computational accuracy change amount is less than the robustness level (step S12: NO), then the sample generation unit 33 increases the perturbation level by a prescribed amount (step S13). For example, the sample generation unit 33 increases the perturbation level by 0.01 times the maximum value of the input signals. Furthermore, the robustness setting device 30 returns the process to step S3 and generates adversarial samples on the basis of the increased perturbation level. Similarly, the computation device 10 calculates multiple output signals with multiple adversarial samples based on the increased perturbation level as inputs. The robustness setting device 30 specifies a computational accuracy change amount corresponding to the increased perturbation level on the basis of multiple output signals following computation, and performs the determination in step S12.

Meanwhile, if the computational accuracy change amount is equal to or greater than the robustness level (step S12: YES), then the level determination unit 36 determines the quantization width to be set in the computation device 10 to be a value that is twice the current perturbation level (step S14). If the computational accuracy change amount is equal to or greater than the robustness level, then this indicates that the desired computational accuracy change amount is achieved by the adversarial samples based on the current perturbation level. In other words, it indicates that the adversarial samples correspond to the set robustness level. The setting of the quantization width will be explained below.

The level determination unit 36 outputs the determined quantization width to the computation device 10 (step S15). The quantization unit 12 in the computation device 10 sets the quantization width input from the robustness setting device 30 as a parameter used in the quantization process (step S16).

As a result thereof, the computation device 10 can acquire robustness against the adversarial samples. The computation device 10 can determine a quantization width for acquiring (achieving) robustness against adversarial samples corresponding to a robustness level input by the user. Additionally, the minimum quantization width with which robustness is achieved can be determined.

<<Operations of Computation Device after Acquiring Robustness>>

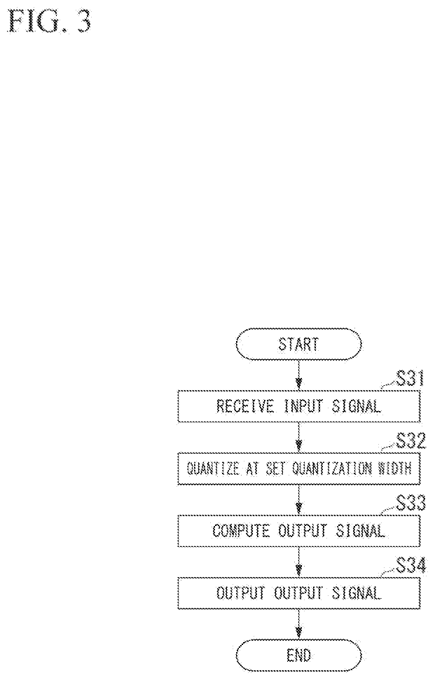

FIG. 3 is a flow chart indicating the operations in the computation device after acquiring robustness according to the first embodiment.

When an input signal is provided to the computation device 10 in which a quantization width has been set by the robustness setting device 30 in accordance with the robustness setting process, the sample input unit 11 receives the input signal (step S31). Next, the quantization unit 12 uses the quantization width set by the robustness setting process indicated by the flow chart in FIG. 2 to perform an input signal quantization process (step S32).

Specifically, a quantization process is performed on the basis of Expression (2) below. That is, the quantization unit 12 rounds off a value obtained by dividing the difference between the input signal x and an input signal minimum value xₘᵢₙ by the quantization width d to obtain an integer. Then, the quantization unit 12 multiplies the quantization width d with the integer-converted value and further adds the input signal minimum value xₘᵢₙ thereby obtaining a quantized input signal x_{q}. In expression (2), the “int” function returns the integer part of a value provided as a variable. In other words, int(X+0.5) indicates a process for conversion to integers by rounding off

$${x}_{q} = d \times int ( \frac{x - {x}_{min}}{d} + 0.5 ) + {x}_{min} \qquad ( 2 )$$

The computation unit 14 computes an output signal by inputting a quantized input signal to the computational model stored in the computational model storage unit 13 (step S33). The computation unit 14 outputs the computed output signal (step S34).

Thus, the computation device 10 quantizes the input signal in accordance with the quantization width determined by the robustness setting device 30. By quantizing an input signal in accordance with the determined quantization width, the computational accuracy can be maintained even in a case in which an adversarial sample corresponding to the set robustness level is input. In other words, the computation device 10 has robustness against adversarial samples corresponding to the robustness level.

### <<Functions and Effects>>

The reason why the computation device 10 can obtain robustness against adversarial samples by setting the quantization width by means of the robustness setting device 30 will be explained.

A computational model that has been sufficiently trained will have robustness against normal noise, such as white noise, even if it is vulnerable against adversarial samples associated with prescribed perturbation levels. That is, even if white noise of the same level as the perturbation level in an adversarial sample is added to an input signal, the computational accuracy of the computational model will not become significantly lower. This shows that, unless the noise included in an input signal is similar to a perturbation associated with an adversarial sample, the computational accuracy of the computational model will not become significantly lower.

In this case, the quantization width set by the robustness setting device 30 is twice the perturbation level of an adversarial sample. Therefore, a quantized input signal obtained by quantizing a normal input signal with the quantization width will match a quantized sample obtained by quantizing an adversarial sample (input signal). As mentioned above, in Expression (1) used when generating the adversarial samples, the “sign” function quantizes the sign as a binary ±value. For this reason, the quantization width is set to a value that is twice the perturbation level E. Quantization noise generated by this quantization is very likely to be different from a perturbation of an adversarial sample. Therefore, by using a quantized input signal as the input to the computational model, the computational accuracy can be prevented from being reduced even if an adversarial sample is input. Since the computational model already has robustness against noise that is not a perturbation in an adversarial sample, the computational device 10 can perform computations with a certain accuracy without having to retrain the computational model after the quantization width has been set.

Thus, the robustness setting device 30 according to the first embodiment specifies the robustness level required in the computation device 10 with respect to adversarial samples, and determines a quantization width of input signals on the basis of the robustness level. As a result thereof, the robustness setting device 30 can easily determine the quantization width that should be set in order for the computation device 10 to acquire robustness.

Additionally, the robustness setting device 30 according to the first embodiment specifies the robustness level on the basis of the perturbation level in an adversarial sample. As a result thereof, the robustness setting device 30 can set the quantization width so as to nullify perturbations in prescribed adversarial samples.

Additionally, the robustness setting device 30 according to the first embodiment specifies the robustness level on the basis of the computational accuracy of the computation device 10 with respect to adversarial samples for each of multiple perturbation levels. As a result thereof, the user can easily set an appropriate robustness level.

According to the first embodiment, the robustness setting device 30 determines an appropriate quantization width by increasing the perturbation level while comparing the computational accuracy change amount with a robustness level input by the user. However, there is no limitation thereto. For example, the robustness setting device 30 may present the user with a computational accuracy for each of multiple perturbation levels, and a user may input robustness levels to the robustness setting device 30 on the basis of the presented computational accuracies.

### Second Embodiment

In a robustness setting system according to a second embodiment, when specific adversarial samples are known, the computation device 10 acquires robustness against the known adversarial samples.

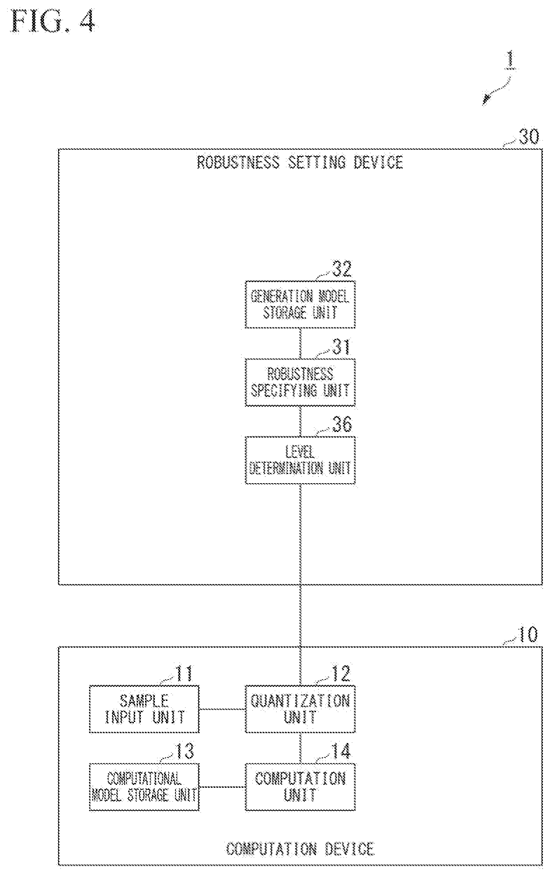

FIG. 4 is a schematic block diagram illustrating a structure of the robustness setting system according to the second embodiment.

In the robustness setting system according to the second embodiment, the structure of the robustness setting device 30 differs from that in the first embodiment. In the robustness setting device 30 according to the second embodiment, the operations of the robustness specifying unit 31 differ from those in the first embodiment. Additionally, the robustness setting device 30 according to the second embodiment does not need to be provided with the sample generation unit 33, the sample output unit 34, and the accuracy specifying unit 35.

The robustness specifying unit 31 analyzes the generation model stored in the generation model storage unit 32 and specifies an adversarial sample perturbation level as the robustness level. In other words, the robustness setting device 30 provides the computation device 10 with robustness against adversarial samples associated with the specified perturbation level.

### <<Operations of Robustness Setting System>>

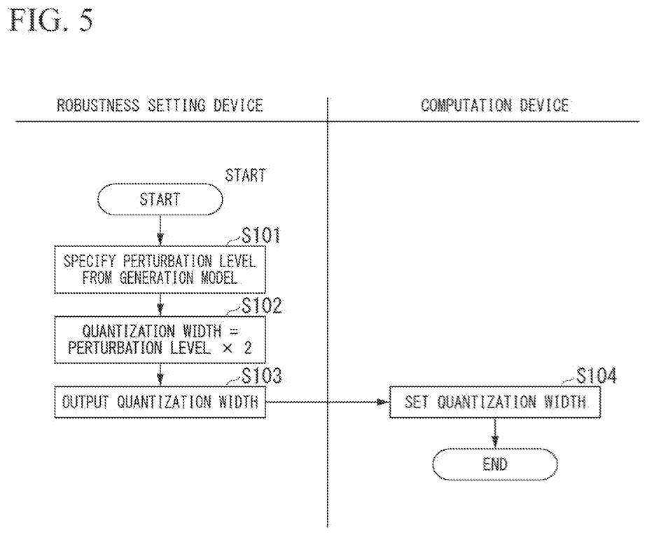

FIG. 5 is a flow chart indicating a robustness setting method in the robustness setting system according to the second embodiment.

The robustness specifying unit 31 analyzes the generation model stored in the generation model storage unit 32 and specifies an adversarial sample perturbation level as the robustness level (step S101). There are various techniques for specifying a perturbation level by analyzing a generation model. The level determination unit 36 determines the quantization width set in the computation device 10 as a value that is twice the perturbation level specified in step S101 (step S102). The level determination unit 36 outputs the determined quantization width to the computation device 10 (step S103). The quantization unit 12 in the computation device 10 sets the quantization width input from the robustness setting device 30 as a parameter used in the quantization process (step S104).

As a result thereof, the computation device 10 can acquire robustness against adversarial samples.

### <<Functions and Effects>>

Thus, the robustness setting device 30 according to the second embodiment specifies the robustness level based on the perturbation levels of known adversarial samples, and determines a quantization width of input signals on the basis of the robustness level. As a result thereof, the robustness setting device 30 can easily determine the quantization width that should be set in order for the computation device 10 to acquire robustness.

The robustness setting device 30 according to the second embodiment specifies the robustness level on the basis of the perturbation level of adversarial samples. However, there is no limitation thereto. For example, the robustness setting device 30 according to another embodiment could specify the robustness level on the basis of a distribution distance index between the adversarial samples and input signals. An example of a distribution distance index is KL divergence (Kullback Leibler divergence). A distribution distance index between the adversarial samples and input signals is a value relating to the perturbation level.

Additionally, the robustness setting device 30 according to the second embodiment specifies the robustness level on the basis of analysis of the generation model. However, there is no such limitation. For example, in another embodiment, the robustness setting device 30 does not store a generation model and specifies the perturbation level by analyzing the adversarial samples and the input signals. However, there is no such limitation.

### Third Embodiment

The robustness setting system according to the second embodiment reliably controls vulnerability against specific adversarial samples. Meanwhile, the computation device 10 obtains robustness against adversarial samples by means of quantization. The larger the quantization width, the greater the loss of information is. For this reason, there is a desire to prevent loss of information even while acquiring robustness against adversarial samples.

In a robustness setting system according to a third embodiment, when a specific adversarial sample is known, the computation device 10 is made to acquire enough robustness, against the known adversarial sample, which allows it to obtain a degree of a computational accuracy of a level required by the user.

### <<Structure of Robustness Setting Device>>

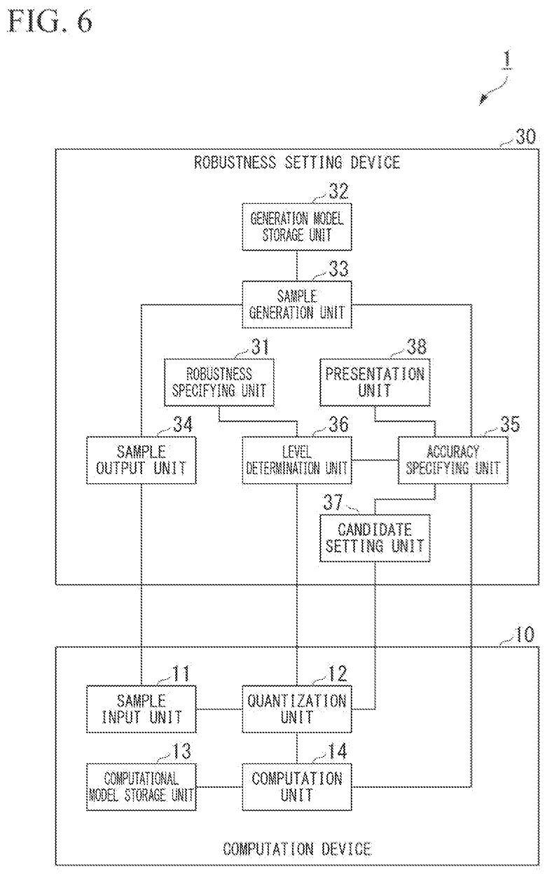

FIG. 6 is a schematic block diagram illustrating a structure of the robustness setting system according to the third embodiment.

The robustness setting device 30 in the robustness setting system 1 according to the third embodiment is further provided with a candidate setting unit 37 and a presentation unit 38 in addition to the structure of the first embodiment. In the robustness setting device 30 according to the second embodiment, the operations of the sample generation unit 33, the accuracy specifying unit 35, the robustness specifying unit 31, and the level determination unit 36 are different from those in the first embodiment.

The candidate setting unit 37 sets multiple quantization width candidates in the quantization unit 12 in the computation device 10. As a result thereof, the computation device 10 performs computations on adversarial samples quantized with different quantization widths.

The sample generation unit 33 generates adversarial samples by using a perturbation level defined in a generation model stored in the generation model storage unit 32. In other words, the sample generation unit 33 generates adversarial samples in accordance with a predetermined perturbation level.

The accuracy specifying unit 35 compares the output signals generated by the computation device 10 on the basis of the adversarial samples with correct response signals specified by the sample generation unit 33, and specifies the computational accuracy of the computation device 10. The accuracy specifying unit 35 specifies the computational accuracy of the computation device 10 for each quantization width candidate set by the candidate setting unit 37.

The presentation unit 38 presents the computational accuracy for each quantization width candidate specified by the accuracy specifying unit 35 on a display or the like.

The robustness specifying unit 31 receives, as robustness levels from the user, one computational accuracy selected, for each quantization width candidate presented on the presentation unit 38. In other words, the robustness setting device 30 provides the computation device 10 with enough robustness against the adversarial samples to achieve the input (received) computational accuracy.

The level determination unit 36 determines the quantization width of the quantization process performed by the quantization unit 12 in the computation device 10 to be a quantization width associated with the computational accuracy associated with the robustness level specified by the robustness specifying unit 31. The level determination unit 36 sets the determined quantization width in the computation device 10.

### <<Operations of Robustness Setting System>>

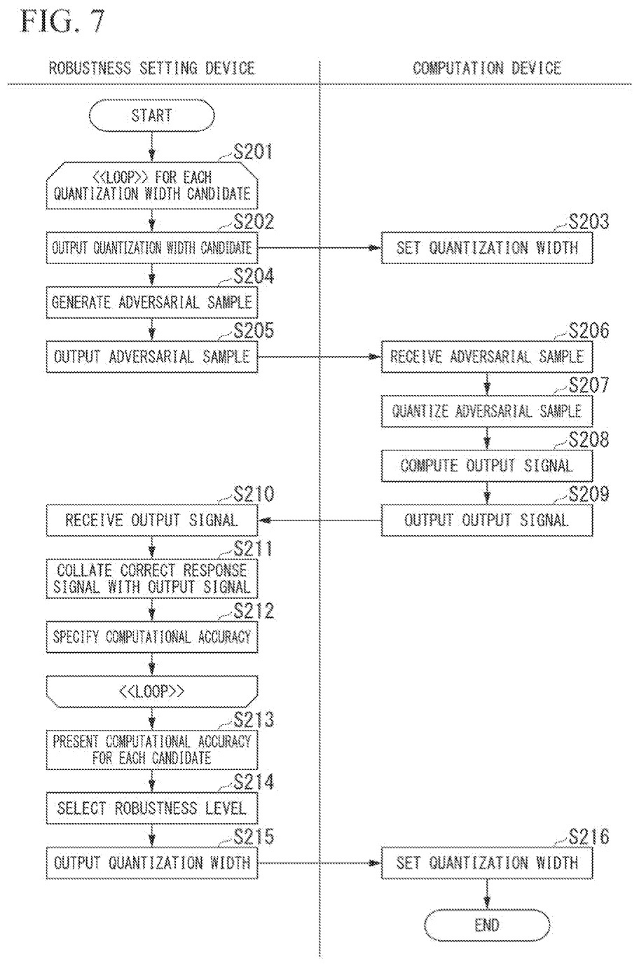

FIG. 7 is a flow chart indicating a robustness setting method in the robustness setting system according to the third embodiment.

The candidate setting unit 37 in the robustness setting device 30 selects the multiple quantization width candidates (for example, 16 quantization width candidates from 1 bit to 16 bits) one at a time (step S201). Furthermore, the robustness setting device 30 performs the processes from step S202 to step S212 below for all of the quantization width candidates.

The candidate setting unit 37 outputs the quantization width candidates selected in step S201 to the computation device 10 (step S202). The quantization unit 12 in the computation device 10 sets the quantization width candidates received from the robustness setting device 30 as parameters used in quantization processes (step S203).

The sample generation unit 33 generates multiple adversarial samples on the basis of input signals associated with known test datasets and the generation model stored in the generation model storage unit 32 (step S204). The sample output unit 34 outputs the multiple adversarial samples that have been generated to the computation device 10 (step S205).

The sample input unit 11 in the computation device 10 receives the multiple adversarial samples as inputs from the robustness setting device 30 (step S206). The quantization unit 12 uses the quantization width candidates set in step S203 to quantize the multiple adversarial samples (step S207). The computation unit 14 computes multiple output signals by inputting, to the computational model stored in the computational model storage unit 13, each of the multiple adversarial samples that have been quantized (step S208). The computation unit 14 outputs the multiple output signals that have been computed to the robustness setting device 30 (step S209).

The accuracy specifying unit 35 in the robustness setting device 30 receives the multiple output signals as inputs from the computation device 10 (step S210). The accuracy specifying unit 35 collates correct response signals corresponding to the input signals used to generate the adversarial samples in step S204 with the output signals that have been received (step S211). The accuracy specifying unit 35 specifies the computational accuracy of the computation device 10 based on the collation results (step S212). The accuracy specifying unit 35 can specify a computational accuracy for each quantization width candidate by performing the above-described process for each quantization width candidate.

When the accuracy specifying unit 35 specifies a computational accuracy for all of the quantization width candidates, the presentation unit 38 presents the computational accuracy for each specified quantization width candidate on a display or the like (step S213). The user views the display, decides on a computational accuracy, from among the multiple computational accuracies that are displayed, as a robustness against adversarial samples required in the computation device 10, and inputs the computational accuracy to the robustness setting device 30.

The robustness specifying unit 31 receives, as robustness levels from the user, one computational accuracy for each quantization width candidate presented on the presentation unit 38 (step S214).

The level determination unit 36 determines the quantization width candidate associated with the computational accuracy selected in step S214 as the quantization width of the quantization process to be performed by the quantization unit 12 in the computation device 10. The level determination unit 36 outputs the determined quantization width to the computation device 10 (step S215). The quantization unit 12 of the computation device 10 sets the quantization width input from the robustness setting device 30 as a parameter used in the quantization process (step S216).

As a result thereof, the computation device 10 can acquire a desired robustness against adversarial samples.

### <<Functions and Effects>>

Thus, the robustness setting system 1 according to the third embodiment specifies, for each of multiple quantization width candidates, an output accuracy of the computation device 10 for adversarial samples quantized on the basis of those quantization width candidates. Additionally, the robustness setting system 1 decides on a quantization width candidate satisfying a desired robustness level among multiple quantization width candidates as the quantization width of the computation device 10. As a result thereof, the user can make the computation device 10 acquire a desired robustness such that loss of information is prevented even while acquiring robustness against adversarial samples.

### Fourth Embodiment

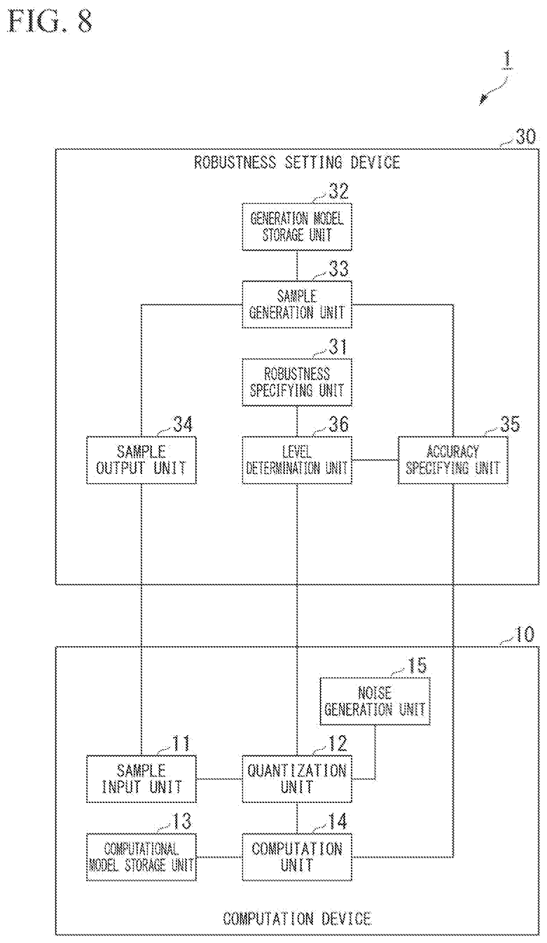

FIG. 8 is a schematic block diagram illustrating a structure of a robustness setting system according to a fourth embodiment.

In the robustness setting system 1 according to the fourth embodiment, the structure of the computation device 10 differs from that in the first embodiment. The computation device 10 according to the fourth embodiment is provided with a noise generation unit 15 in addition to the structure in the first embodiment, and the calculations in the quantization unit 12 differ from those in the first embodiment.

The noise generation unit 15 generates random numbers that are greater than or equal to 0 and less than or equal to 1. Examples of random numbers include uniformly distributed random numbers and random numbers based on a Gaussian distribution. Additionally, in another embodiment, the noise generation unit 15 may generate a pseudorandom number instead of a random number. Random numbers and pseudorandom numbers are an example of noise.

The quantization unit 12 performs a quantization process based on Expression (3) below. That is, the quantization unit 12 extracts the integer part of a value obtained by adding the random number generated by the noise generation unit 15 to a value obtained by dividing the difference between an input signal x and an input signal minimum value xₘᵢₙ by the quantization width d. The quantization unit 12 multiplies the quantization width d to the extracted integer part, and further adds the input signal minimum value xₘᵢₙ to obtain a quantized input signal x_{q}.

$${x}_{q} = d \times int ( \frac{x - {x}_{min}}{d} + p ) + {x}_{min} \qquad ( 3 )$$

### <<Functions and Effects>>

According to the fourth embodiment, the computation device 10 uses a random number to quantize input signals. That is, the computation device 10 uses random numbers to perform probabilistic quantization. As a result thereof, even if the same input signal is input to the computation device 10, the output signals generated by the computation device 10 slightly change. For this reason, the computation device 10 can make it difficult to estimate the computational model provided in the computation device 10 on the basis of pairs of input signals and output signals. Since it becomes difficult to estimate the computational model, it becomes difficult for an attacker to make an adversarial sample generation model. Thus, the risk that the computation device 10 will be attacked by adversarial samples can be reduced.

In the fourth embodiment, quantization using random numbers is performed on the basis of the above Expression (3). However, there is no limitation thereto. For example, in another embodiment, the computation device 10 may perform the quantization by adding a random number in the range ±d/2 to the above Expression (2).

### Fifth Embodiment

As a fifth embodiment, a robustness evaluation system that evaluates the robustness of a computation device 10 against adversarial samples will be described.

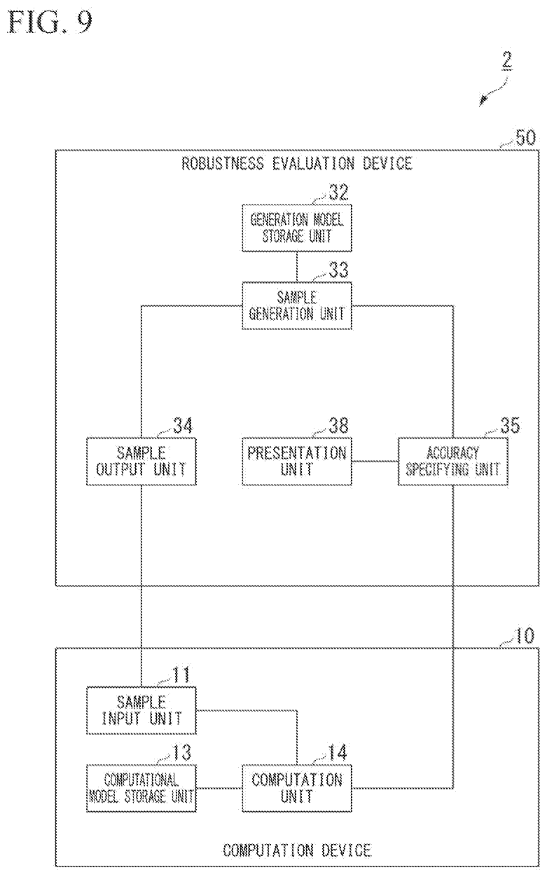

FIG. 9 is a schematic block diagram illustrating a structure of the robustness evaluation system according to the fifth embodiment.

The robustness evaluation system 2 is provided with a computation device 10 and a robustness evaluation device 50. Although the structure of the computation device 10 is similar to that in the first embodiment, the computation device 10 in the fifth embodiment does not need to be provided with a quantization unit 12.

### <<Structure of Robustness Evaluation Device>>

The robustness evaluation device 50 evaluates the robustness of the computation device 10 against adversarial samples.

The robustness evaluation device 50 is provided with a generation model storage unit 32, a sample generation unit 33, a sample output unit 34, an accuracy specifying unit 35, and a presentation unit 38. The generation model storage unit 32, the sample generation unit 33, the sample output unit 34, and the accuracy specifying unit 35 perform processes similar to those performed by the generation model storage unit 32, the sample generation unit 33, the sample output unit 34, and the accuracy specifying unit 35 provided in the robustness setting device 30 in the first embodiment.

The presentation unit 38 presents the computational accuracy for each adversarial sample perturbation level.

### <<Operations of Robustness Setting System>>

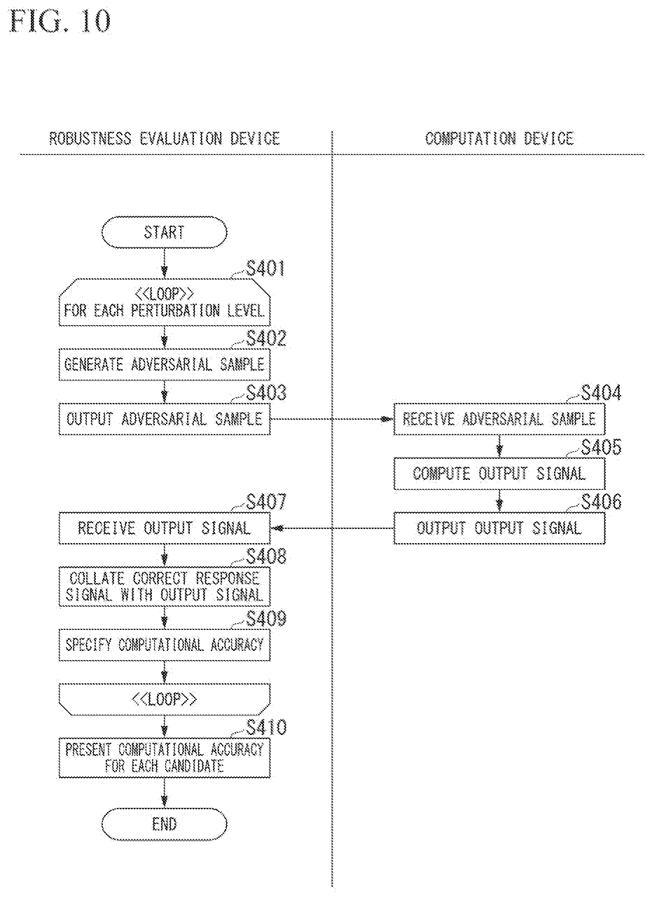

FIG. 10 is a flow chart indicating a robustness evaluation method in the robustness evaluation system according to the fifth embodiment.

The robustness evaluation device 50 selects multiple perturbation levels (for example, 16 perturbation levels from 1 bit to 16 bits) one at a time (step S401), and performs the process from step S402 to step S409 below for all of the perturbation levels.

Multiple adversarial samples are generated on the basis of input signals associated with known test datasets, the perturbation levels selected in step S401, and the generation model stored in the generation model storage unit 32 (step S402). The sample output unit 34 outputs the multiple adversarial samples that have been generated to the computation device 10 (step S403).

The sample input unit 11 in the computation device 10 receives the multiple adversarial samples as inputs from the robustness setting device 30 (step S404). The computation unit 14 computes multiple output signals by inputting each of the multiple adversarial samples that have been received to the computational model stored in the computational model storage unit 13 (step S405). The computation unit 14 outputs the multiple output signals that have been computed to the robustness setting device 30 (step S406).

The accuracy specifying unit 35 in the robustness setting device 30 receives the multiple output signals as inputs from the computation device 10 (step S407). The accuracy specifying unit 35 collates correct response signals corresponding to the input signals used to generate the adversarial samples in step S402 with the output signals that have been received (step S408). The accuracy specifying unit 35 specifies the computational accuracy of the computation device 10 based on the collation results (step S409). The accuracy specifying unit 35 can specify a computational accuracy for each perturbation level by performing the above-described process for each perturbation level.

When the accuracy specifying unit 35 specifies a computational accuracy for all of the perturbation levels, the presentation unit 38 presents the computational accuracy for each specified perturbation level on a display or the like (step S410). By viewing the display, a user can recognize the perturbation levels at which the computational accuracy drops in the computation device 10. In other words, by using the robustness evaluation device 50, the user can recognize the robustness of the computation device 10 against adversarial samples.

### OTHER EMBODIMENTS

While embodiments have been explained in detail by referring to the drawings above, the specific structure is not limited to those mentioned above, and various design changes and the like are possible. For example, in another embodiment, the sequence of the above-described processes may be changed as appropriate. Additionally, some of the processes may be performed in parallel.

The robustness setting device 30 and the computation device 10 according to the above-described embodiments increase the robustness against adversarial samples by performing quantization processes on input signals. However, there is no limitation thereto. For example, the robustness setting device 30 and the computation device 10 according to another embodiment may increase the robustness against adversarial samples by means of a lowpass filter process or by another noise removal process. When increasing the robustness by means of a filter, the level determination unit 36 of the robustness setting device 30 determines filter weights as noise removal levels.

Additionally, although the computation device 10 in the robustness setting system 1 according to the above-described embodiments does not perform retraining after the quantization width has been set, retraining may be performed after the quantization width has been set in another embodiment. Even in the case of retraining, retraining can be completed with a shorter calculation time in comparison with normal retraining using adversarial samples as teacher data.

### <Basic Structure>

### <<Basic Structure of Robustness Setting Device>>

FIG. 11 is a schematic block diagram illustrating a basic structure of a robustness setting device.

In the above-described embodiments, the structures indicated in FIG. 1, FIG. 4, FIG. 6 and FIG. 8 were explained as embodiments of the robustness setting device 30. However, the basic structure of the robustness setting device 30 is that illustrated in FIG. 11.

In other words, the robustness setting device 30 has a robustness specifying unit 301 and a level determination unit 302 as the basic structure.

The robustness specifying unit 301 specifies a robustness level required in a computation device using a trained model with respect to adversarial samples, which are input signals to which perturbations have been added in order to induce erroneous determinations in the trained model. The robustness specifying unit 301 corresponds to the robustness specifying unit 31 in the above-described embodiment.

The level determination unit 302 determines the noise removal level of input signals based on the robustness level. The level determination unit 302 corresponds to the level determination unit 36 in the above-mentioned embodiments.

As a result thereof, the robustness setting device 30 can simply provide a computation device using a trained model with robustness against adversarial samples.

### <<Basic Structure of Computation Device>>

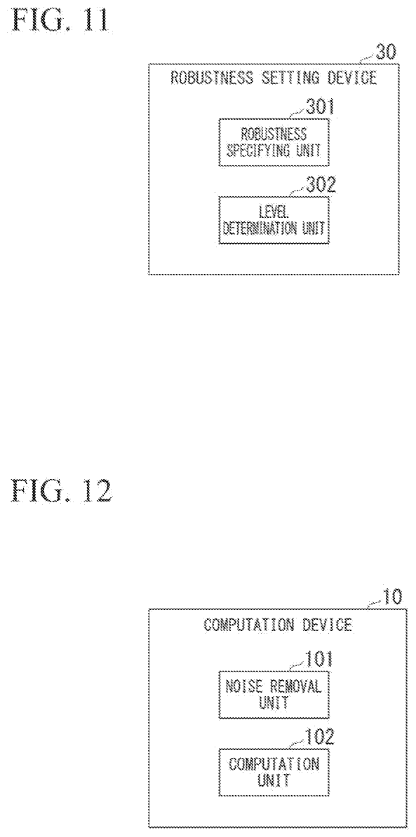

FIG. 12 is a schematic block diagram illustrating a basic structure of a computation device.

In the above-described embodiments, the structures indicated in FIG. 1, FIG. 4, FIG. 6 and FIG. 8 were explained as embodiments of the computation device 10. However, the basic structure of the computation device 10 is that illustrated in FIG. 11.

In other words, the computation device 10 has a noise removal unit 101 and a computation unit 102 as the basic structure.

The noise removal unit 101 performs a noise removal process on input signals on the basis of the noise removal level determined by the robustness setting method in the robustness setting device 30. The noise removal unit 101 corresponds to the quantization unit 12 in the above-mentioned embodiment.

The computation unit 102 obtains output signals by inputting, to a trained model, the input signals that have been subjected to the noise removal process. The computation unit 102 corresponds to the computation unit 14 in the above-described embodiments.

As a result thereof, the computation device 10 can simply acquire robustness against adversarial samples.

### <<Basic Structure of Robustness Evaluation Device>>

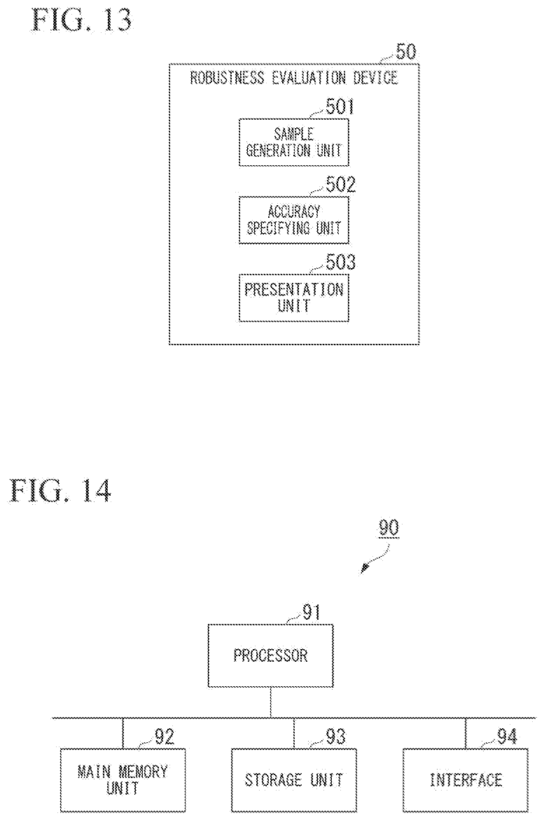

FIG. 13 is a schematic block diagram illustrating a basic structure of a robustness setting device.

In the above-described embodiments, the structures indicated in FIG. 9 were explained as embodiments of the robustness evaluation device 50. However, the basic structure of the robustness evaluation device 50 is that illustrated in FIG. 13.

In other words, the robustness evaluation device 50 has a sample generation unit 501, an accuracy specifying unit 502, and a presentation unit 503 as the basic structure.

The sample generation unit 501 generates multiple adversarial samples for each of multiple perturbation levels for inducing erroneous determinations in a trained model. The sample generation unit 501 corresponds to the sample generation unit 33 in the above-described embodiments.

The accuracy specifying unit 502 specifies an output accuracy of the computation device using the trained model with respect to adversarial samples, for each of the multiple perturbation levels. The accuracy specifying unit 502 corresponds to the accuracy specifying unit 35 in the above-described embodiments.

The presentation unit 503 presents information indicating robustness levels of the computation device against adversarial samples based on the output accuracy for each of the multiple perturbation levels. The presentation unit 503 corresponds to the presentation unit 38 in the above-described embodiments.

As a result thereof, the robustness evaluation device 50 can evaluate the robustness of a computation device using a trained model against adversarial samples.

### <Computer Structure>

FIG. 14 is a schematic block diagram illustrating a structure of a computer according to at least one embodiment.

The computer 90 is provided with a processor 91, a main memory unit 92, a storage unit 93, and an interface 94.

The computation device 10, the robustness setting device 30, and the robustness evaluation device 50 described above are installed in a computer 90. Furthermore, the operations of the respective processing units described above are stored in the storage unit 93 in the form of a program. The processor 91 reads the program from the storage unit 93, loads the program in the main memory unit 92, and executes the above-described processes in accordance with said program. Additionally, the processor 91 secures a storage area corresponding to each of the above-mentioned storage units in the main memory unit 92 in accordance with the program. Examples of the processor 91 include a CPU (Central Processing Unit), a GPU (Graphic Processing Unit), a microprocessor, and the like.

The program may be for implementing just some of the functions to be performed by the computer 90. For example, the program may perform the functions by being combined with another program already stored in the storage unit, or by being combined with another program installed in another device. In other embodiments, the computer 90 may be provided with a custom LSI (Large Scale Integrated Circuit) such as a PLD (Programmable Logic Device) in addition to or instead of the structure described above. Examples of PLDs include PAL (Programmable Array Logic), GAL (Generic Array Logic), CPLD (Complex Programmable Logic Device), and FPGA (Field Programmable Gate Array). In this case, some or all of the functions performed by the processor 91 may be performed by these integrated circuits. Such integrated circuits are included as examples of processors.

Examples of the storage unit 93 include an HDD (Hard Disk Drive), an SSD (Solid State Drive), a magnetic disk, a magneto-optic disk, a CD-ROM (Compact Disc Read-Only Memory), a DVD-ROM (Digital Versatile Disc Read-Only Memory), a semiconductor memory unit, or the like. The storage unit 93 may be internal media directly connected to a bus in the computer 90, or may be external media connected to the computer 90 via the interface 94 or a communication line. Additionally, in the case in which this program is transmitted to the computer 90 by means of a communication line, the computer 90 that has received the transmission may load the program in the main memory unit 92 and execute the above-described processes. In at least one embodiment, the storage unit 93 is a non-transitory tangible storage medium.

Additionally, the program may be for performing just some of the aforementioned functions.

Furthermore, the program may be a so-called difference file (difference program) that performs the functions by being combined with another program that is already stored in the storage unit 93.

Some or all of the above-described embodiments may be described as indicated in the supplementary notes below, but they are not limited to those indicated below.

### (Supplementary Note 1)

A robustness setting device comprising:

a robustness specifying unit for specifying a robustness level required in a computation device using a trained model against an adversarial sample that is an input signal to which a perturbation has been added in order to induce an erroneous determination by the trained model; and a level determination unit for determining a noise removal level for the input signal based on the robustness level.

### (Supplementary Note 2)

The robustness setting device according to supplementary Note 1, wherein: the noise removal level is a quantization parameter of the input signal.

### (Supplementary Note 3)

The robustness setting device according to supplementary Note 1 or supplementary Note 2, comprising:

an accuracy specifying unit for specifying, for each of multiple noise removal level candidates of different values, an output accuracy of the computation device with respect to the adversarial samples that have been subjected to a noise removal process based on that noise removal level candidate,

wherein the robustness specifying unit specifies an output accuracy satisfying the robustness level from among output accuracies for each of the multiple noise removal level candidates, and

wherein the level determination unit determines the noise removal level for the input signal as being the noise removal level candidate associated with the specified output accuracy.

### (Supplementary Note 4)

The robustness setting device according to supplementary Note 1 or supplementary Note 2, wherein:

the robustness specifying unit specifies the robustness level based on the perturbation levels of the adversarial samples.

### (Supplementary Note 5)

The robustness setting device according to supplementary Note 4, comprising:

a sample generation unit for generating multiple adversarial samples for each of the multiple perturbation levels; and

an accuracy specifying unit for specifying an output accuracy of the computation device with respect to the adversarial samples for each of the multiple perturbation levels,

wherein the robustness specifying unit specifies the robustness level based on the output accuracy for each of the perturbation levels.

### (Supplementary Note 6)

A robustness setting method comprising:

a step for specifying a robustness level required in a computation device using a trained model against an adversarial sample that is an input signal to which a perturbation has been added in order to induce an erroneous determination by the trained model; and

a step for determining a noise removal level for the input signal based on the robustness level.

### (Supplementary Note 7)

A robustness setting program for making a computer execute:

a step for specifying a robustness level required in a computation device using a trained model against an adversarial sample that is an input signal to which a perturbation has been added in order to induce an erroneous determination by the trained model; and

a step for determining a noise removal level for the input signal based on the robustness level.

### (Supplementary Note 8)

A robustness evaluation device comprising:

a sample generation unit for generating multiple adversarial samples for each of multiple perturbation levels for inducing an erroneous determination in a trained model;

an accuracy specifying unit for specifying an output accuracy of the computation device using the trained model with respect to the adversarial samples for each of the multiple perturbation levels; and

a presentation unit for presenting information indicating a robustness level of the computation device against the adversarial samples based on the output accuracy for each of the multiple perturbation levels.

### (Supplementary Note 9)

A robustness evaluation method comprising:

a step for generating multiple adversarial samples for each of multiple perturbation levels for inducing an erroneous determination in a trained model;

a step for specifying an output accuracy of the computation device using the trained model with respect to the adversarial samples for each of the multiple perturbation levels; and

a step for presenting information indicating a robustness level of the computation device against the adversarial samples based on the output accuracy for each of the multiple perturbation levels.

(Supplementary Note 10) A robustness evaluation program for making a computer execute:

a step for generating multiple adversarial samples for each of multiple perturbation levels for inducing an erroneous determination in a trained model;

a step for specifying an output accuracy of the computation device using the trained model with respect to the adversarial samples for each of the multiple perturbation levels; and

a step for presenting information indicating a robustness level of the computation device against the adversarial samples based on the output accuracy for each of the multiple perturbation levels.

### (Supplementary Note 11)

A computation device comprising:

a noise removal unit for performing a noise removal process on an input signal based on a noise removal level determined by the robustness setting method according to supplementary Note 6; and

a computation unit for obtaining an output signal by inputting, to a trained model, the input signal that has been subjected to the noise removal process.

### (Supplementary Note 12)

The computation device according to supplementary Note 11, comprising:

a random number generation unit for generating random numbers,

wherein the noise removal unit uses the random numbers to perform a noise removal process on the input signal based on the noise removal level.

### (Supplementary Note 13)

A computation method comprising:

a step for performing a noise removal process on an input signal based on a noise removal level determined by the robustness setting method according to supplementary Note 6; and

a step for obtaining an output signal by inputting, to a trained model, the input signal that has been subjected to the noise removal process.

### (Supplementary Note 14)

A program for making a computer execute:

a step for performing a noise removal process on an input signal based on a noise removal level determined by the robustness setting method according to supplementary Note 6; and

a step for obtaining an output signal by inputting, to a trained model, the input signal that has been subjected to the noise removal process.

The present application claims the benefit of priority based on Japanese Patent Application No. 2019-090066, filed May 10, 2019, the entire disclosure of which is incorporated herein by reference.

### INDUSTRIAL APPLICABILITY

A computation device using a trained model can be simply provided with robustness against adversarial samples.

### REFERENCE SIGNS LIST

1 Robustness setting system
2 Robustness evaluation system
10 Computation device
11 Sample input unit
12 Quantization unit
13 Computational model storage unit
14 Computation unit
15 Noise generation unit
30 Robustness setting device
31 Robustness specifying unit
32 Generation model storage unit
33 Sample generation unit
34 Sample output unit
35 Accuracy specifying unit
36 Level determination unit
37 Candidate setting unit
38 Presentation unit
50 Robustness evaluation device

What is claimed is:

1. A robustness setting device comprising:
at least one memory configured to store instructions; and
at least one processor configured to execute the instructions to;
specify a robustness level required in a computation device using a trained model against an adversarial sample that is an input signal to which a perturbation has been added in order to induce an erroneous determination by the trained model; and
determine a noise removal level for the input signal based on the robustness level.

2. The robustness setting device according to claim 1,
wherein the at least one processor is configured to execute the instructions to specify the robustness level based on a perturbation level of the perturbation in the adversarial sample.

3. The robustness setting device according to claim 2,
wherein the at least one processor is further configured to execute the instructions to:
generate multiple adversarial samples for each of multiple perturbation levels; and
specify an output accuracy of the computation device with respect to the adversarial samples for each of the multiple perturbation levels,
wherein the at least one processor is configured to execute the instructions to specify the robustness level based on the output accuracy for each perturbation level.

4. A robustness setting method comprising:
specifying a robustness level required in a computation device using a trained model against an adversarial sample that is an input signal to which a perturbation has been added in order to induce an erroneous determination by the trained model; and
determining a noise removal level for the input signal based on the robustness level.

5-6. (canceled)

7. A robustness evaluation method comprising:
generating multiple adversarial samples for each of multiple perturbation levels for inducing an erroneous determination by a trained model;
specifying an output accuracy of a computation device using the trained model with respect to the adversarial samples for each of the multiple perturbation levels; and
presenting information indicating a robustness level of the computation device against the adversarial samples based on the output accuracy for each of the multiple perturbation levels.

8-10. (canceled)
